(19) United States
(12) Patent Application Publication
(10) Pub. No.: US 2013/0202755 A1
(43) Pub. Date: Aug. 8, 2013

(54) METHOD FOR PRESERVING FRESH CUT LEMON

(71) Applicants: Rafael Lopez Insausti, Carcar (ES); Reyes Itoiz Avinzano, Carcar (ES); Silvia Garcia De La Torre, Carcar (ES); Carlos Javier Gonzalez Navarro, Carcar (ES)

(72) Inventors: Rafael Lopez Insausti, Carcar (ES); Reyes Itoiz Avinzano, Carcar (ES); Silvia Garcia De La Torre, Carcar (ES); Carlos Javier Gonzalez Navarro, Carcar (ES)

(73) Assignee: Lunacitric, S.A., Carcar (ES)

(21) Appl. No.: 13/579,899

(22) PCT Filed: Feb. 3, 2011
(86) PCT No.: PCT/ES11/70072

§ 371 Date: Oct. 25, 2012

(30) Foreign Application Priority Data
Feb. 18, 2010 (ES) P 201030234

(51) Int. Cl. A23B 7/10

(52) U.S. Cl. CPC A23B 7/10
USPC 426/392

(57) ABSTRACT

The invention relates to a method for preserving fresh cut lemon, comprising at least the following steps: (a) the addition of a covering liquid to the container housing the portions of cut lemon, said liquid combining lemon juice, lime juice, ascorbic acid, citric acid, salt and sodium metabisulphite; (b) the deaeration of the covering liquid; and (c) vacuum packaging.

The object of the present invention is a method for preserving fresh cut lemon, into slices, sections or pieces, in cans or plastic at room temperature, while maintaining all of its natural organoleptic properties. The objective is achieved a canned food with a duration of the lemon properties comprised between a minimum of four months and two years.

### STATE OF THE PRIOR ART

Currently, the lemon cut into pieces and slices is preserved by different methods. The most common of them is freezing, where the fresh lemon, cut into pieces or slices at temperatures below zero degrees, while the one conserved in plastic is at a temperature refrigerated between 2 and 5 degrees, with a maximum duration of one month in preservation.

It has tried to preserve the fresh cut lemon at room temperature in plastic and glass packaging with a result of a preservation of 2 to 2.5 months at a temperature of 20 degrees. Thus, the objective technical problem which solves the present invention is the preservation of fresh cut lemon at room temperature, regardless of the packaging, with a minimum preservation of the organoleptic properties equal or greater than six months.

### EXPLANATION OF THE INVENTION

In order to solve the objective technical problem described, the method for preserving fresh cut lemon, object of the present invention comprises at least the following steps: (a) the addition of a covering liquid to the container housing the portions of cut lemon, said liquid combining lemon juice, lime juice, ascorbic acid, citric acid, salt and sodium metabisulphite; (b) the deaeration of the covering liquid; and (c) vacuum packaging by the addition of an nitrogen or water vapor atmosphere.

Optionally, after the deaeration and packaging, there may be an additional treatment step at high pressures of fresh cut lemon introduced in the covering liquid, of at least 300-600 MPa.

Thanks to the method thus described it is achieve to maintain the slices, sections or half-moons of fresh lemon at room temperature a minimum of four months, and up to two years at a refrigerated temperature.

Throughout the description and claims the word “comprises” and its variants are not intended to exclude other technical features, additives, components or steps. For those skills in the art, other objects, advantages and features of the invention will be understood partly of the description and partly of the practice of the invention. The following examples and drawings are provided by way of illustration, and are not intended to be limiting of the present invention. In addition, the present invention covers all possible combinations of particular and preferred embodiments here indicated.

### DETAILED EXPOSITION OF EMBODIMENTS

In a particular embodiment of the present invention, the method for preserving fresh cut lemon comprises, at least, the following steps:

(a) the addition of a covering liquid to the container housing the portions of fresh cut lemon of a covering liquid essentially made up of lemon juice, lime juice, ascorbic acid, citric acid, salt and sodium metabisulphite;

(b) the deaeration of the covering liquid by applying of vacuum or displacement of oxygen by an inert gas; and

(c) vacuum packaging;

The covering liquid, more specifically, comprises: 65% to 75% of lemon juice; from 25% to 35% of lime juice; from 5% to 0.1% of ascorbic acid; from 5% to 0.1% of citric acid; from 5% to 0.1% of Na₂Cl; and finally a range of sodium metabisulphite from 1 g/l to 0.7 g/l.

### Embodiment of the Covering Liquid

In a practical embodiment of the present invention, the covering liquid is made up by 65% of lemon juice (6.25% of lemon concentrate), 30% of lime juice (6.35 of lime concentrate), 2% of ascorbic acid (antioxidant E-300), 1% of citric acid (acidifier and antioxidant E-330), 1% of salt (Na₂Cl) and from 1 g/l to 0.7 g/l of sodium metabisulphite (preservative E-223). With such composition the covering liquid has the following characteristics:
Density 1.0430 g/l,
pH 2.12,
° Brix 9,25 and
Less than 25 cp of viscosity.

The absence of oxygen is essential for the preservation of the fresh cut lemon, given that one of the factors that cause the non-enzymatic oxidation of ascorbic acid is the presence of oxygen. During the preparation of the product the concentration of oxygen dissolved in the covering liquid is eliminated or reduced by one of the following methods:

(i) replacement of oxygen by an inert gas, by substituting in a practical example oxygen by helium (E-339), which is a noble and inert gas, i.e. this does not react, and whose use is authorized as an alimentary additive (according to RD 1422002), and wherein the replacement has been carried out once formulated the covering liquid by injecting helium at pressure which forms a plurality of micro-bubbles that displace to the dissolved oxygen;

(ii) Removal of oxygen by applying vacuum, wherein it has been used a deaerator consisting of a deposit which also serves as a formulator, a vacuum pump and a compressor, for the vacuum application to the covering liquid; and wherein the covering liquid has been subjected to a given pressure until the oxygen content in the covering liquid is less than 2 mg/l.

Finally, once removed the oxygen present in the covering liquid that bathes the portions of fresh lemon it is proceed to its vacuum packaging by the addition of a nitrogen or water vapor atmosphere.

1. Method for preserving fresh cut lemon characterized in that comprises, at least, the steps of: (a) the addition of a covering liquid to the container housing the portions of cut lemon, said liquid combining lemon juice, lime juice, ascorbic acid, citric acid, salt and sodium metabisulphite; (b) the deaeration of the covering liquid; and (c) vacuum packaging.

2. Method according to the claim 1 characterized in that the covering liquid, more specifically, comprises: from 65% to 75% of lemon juice; from 25% to 35% of lime juice; from 5% to 0.1% of ascorbic acid; from 5% to 0.1% of citric acid; from 5% to 0.1% of salt; and finally a range of sodium metabisulphite from 1 g/l to 0.7 g/l.

3. Method according to the claim 2 characterized in that the covering liquid is made up by 65% of lemon juice, 30% of lime juice, 2% of ascorbic acid, 1% of citric acid, 1% of Na₂Cl and sodium metabisulphite from 1 g/l to 0.7 g/l.

4. Method according to claim 1 characterized in that the deaeration of the covering liquid is carried out by a method selected from: (i) deaeration by oxygen substitution by an inert gas; and (ii) removal of atmosphere by applying vacuum.

5. Method according to the claim 4 characterized in that the deaeration by oxygen substitution by an inert gas is carried out once formulated the covering liquid by injecting helium at pressure which forms a plurality of micro-bubbles that displace to the dissolved oxygen.

6. Method according to the claim 4 characterized in that in the removal of oxygen by applying vacuum it has been used a deaerator consisting of a deposit which also serves as a formulator, a vacuum pump and a compressor, for the vacuum application to the covering liquid; and wherein the covering liquid has been subjected to a given pressure until the oxygen content in the covering liquid is less than 2 mg/l.

7. Method according to claim 1 characterized in that the vacuum packaging occurs after the addition of an atmosphere selected from nitrogen or water vapor.

8. Method according to claim 1 characterized in that after the deaeration and packaging, there is an additional treatment step at high pressures of fresh cut lemon introduced in the covering liquid, wherein said high pressures are of 300-600 MPa.
